(19) United States
(12) Patent Application Publication
(10) Pub. No.: US 2019/0309814 A1
(43) Pub. Date: Oct. 10, 2019

(54) LEAF SPRING DEVICE FOR A VEHICLE AND METHOD FOR PRODUCING SUCH A LEAF SPRING DEVICE

(71) Applicant: ZF Friedrichshafen AG, Friedrichshafen (DE)

(72) Inventors: Marcel PLEYER, Melle (DE); Thomas RUPFLIN, Stetten (DE); Sami Uddin SIDDIQUI, Lemförde (DE); Natalie WIEBER, Schweinfurt (DE); Melanie BRAUN, Schweinfurt (DE); Remt BLANKENSPECK, Barnstorf (DE)

(21) Appl. No.: 16/374,975

(22) Filed: Apr. 4, 2019

(30) Foreign Application Priority Data
Apr. 6, 2018 (DE) 10 2018 205 218.2

(51) Int. Cl. F16F 1/18; B60G 11/02

(52) U.S. Cl. CPC F16F 1/185; B60G 11/02; B60G 2202/11; F16F 2238/022; F16F 2228/14

(57) ABSTRACT

A leaf spring device (1) for a vehicle having a first spring leaf (2) made of a fiber reinforced plastic and at least one further spring leaf (3). The first spring leaf (2) and the further spring leaf (3) interact with one another to implement a progressive suspension. The first spring leaf (2) has a receiving space (4) and the further spring leaf (3) is arranged in the receiving space (4) so as to implement the progressive suspension and/or to increase stability when using such a leaf-spring device (1).

This application claims priority from German patent application serial no. 10 2018 205 218.2 filed Apr. 6, 2018.

### FIELD OF THE INVENTION

The invention relates to a leaf-spring device for a vehicle having a first spring leaf and at least one further spring leaf, wherein the first spring leaf and the further spring leaf interact to implement a progressive suspension. Furthermore, the invention relates to a method for manufacturing such a leaf-spring device, wherein a first spring leaf and at least one further spring leaf are manufactured, and the first spring leaf and the further spring leaf interact to implement a progressive suspension and/or spring characteristic. Finally, the invention relates to the use of such a leaf-spring device as a longitudinal leaf spring or a transverse leaf spring in a chassis of a vehicle or motor vehicle.

### BACKGROUND OF THE INVENTION

Such a leaf-spring device is known from DE 10 2010 015 951 A1. Accordingly, a progressive course of a force-displacement characteristic is made possible when a leaf-spring device is used, which is composed of a plurality of spring leaves, which are each suitably designed and interconnected or arranged in a spring-leaf laminate.

In spring devices made of metal, it is known to use a plurality of spring leaves made of metal of different lengths and/or numbers to implement a progressive suspension. At least one of these spring leaves acts only from a certain or predetermined spring travel, thereby increasing the rigidity of the leaf-spring device. Such an increasing stiffness of the leaf-spring device and/or progressive suspension is required for instance for vehicles of certain weight classes or vehicles having a high payload. As a result, an almost constant natural frequency of the body can be warranted, which increases driving safety.

In a multi-leaf leaf-spring device having at least one spring leaf of a fiber-reinforced plastic there is a risk of undesirable damage occurring in the contact area of the spring leaf of fiber-reinforced plastic with the at least one further spring leaf. In particular, dirt particles carried in and/or abrasion in the area of a contact surface of the spring leaf of the fiber-reinforced plastic with the further spring leaf can result in undesirable damage to the leaf-spring device, endangering the operability and/or reducing the service life of the leaf-spring device. Thus, an increasing rigidity and/or a progressive suspension cannot readily be implemented in a multi-leaf leaf-spring device made of a fiber-plastic composite, in particular glass fiber reinforced plastic.

### SUMMARY OF THE INVENTION

The invention addresses the problem of developing a leaf-spring device and/or a method of the type mentioned in such a way that a progressive suspension can be implemented and/or the required stability during operation can be guaranteed when a leaf-spring device having at least one spring leaf, in particular made of a fiber-reinforced plastic, is used. Preferably, the stiffness of the leaf-spring device should increase as a function of the spring travel and/or spring load. In particular, an alternative embodiment shall be provided.

The problem addressed by the invention is solved by a leaf-spring device according to the independent claims and by means of a method according to the independent claims. Preferred developments of the invention are presented in the subclaims and the description below.

The leaf-spring device is designed for use in a vehicle and/or motor vehicle. In particular, the leaf-spring device is arranged in a chassis of a vehicle and/or motor vehicle. There, the leaf-spring device can be connected to an axle, a rigid axle, a wheel axle, a wheel carrier and/or a transverse link. The axle may be formed as a rear axle or as a front axle. The leaf-spring device can be arranged in the longitudinal direction or in the transverse direction to the longitudinal axis of the vehicle. The leaf-spring device has a first spring leaf and at least one further spring leaf. Thus, the leaf-spring device can comprise at least two or more spring leaves. The leaf-spring device can be designed as double-leaf or multi-leaf. Preferably, the further spring leaf is designed as a second spring leaf. In particular, the leaf-spring device has a single first spring leaf and a single second spring leaf. The first spring leaf and the further spring leaf interact to implement a progressive suspension and/or progressive spring characteristic. In particular, in a progressive suspension and/or spring characteristic, a stiffness of the leaf-spring device is increased from a predetermined spring load and/or upon an increasing spring load. In particular, a progressive suspension can be used to implement a higher or increasing spring rate for an increasing load condition in a vehicle. The stiffness may increase continuously or exponentially, in particular starting from the predetermined spring load.

In a leaf-spring device according to the invention, the first spring leaf has a receiving space, wherein the further spring leaf is arranged in the receiving space.

It is advantageous that, due to the formation of a receiving space hi the first spring leaf, alternative arrangement options are feasible for the further spring leaf. In contrast to conventional arrangements hi a multi-leaf leaf-spring device, in which at least two spring leaves are stacked on top of each other, here the further spring leaf is arranged in the receiving space of the first spring leaf. Thus, the further spring leaf can be arranged inside the first spring leaf. Alternatively, the receiving space may be referred to as an inner space. The receiving space and/or the inner space may be formed as a completely closed chamber or as an open space.

According to a further development, an elastic material is arranged in particular at least partially or at least in part in the receiving space and between the first spring leaf and the further spring leaf, Thus, the first spring leaf and the further spring leaf are not directly abutting each other. As a result, the risk of undesirable damage during the operation of the leaf-spring device is considerably reduced. In particular, the first spring leaf and the further spring leaf are connected to each other by the elastic material. Preferably, the elastic material rests on the one hand on an inner circumference and/or an inner side of the receiving space and on the other hand on an outer circumference and/or an outer side of the further spring leaf, in particular at least partially. The elastic material may be firmly connected to the inner circumference of the receiving space and/or to the outer circumference of the further spring leaf. Preferably, the elastic material is an elastomeric material. An elastomeric material may be an elastically deformable plastic and/or an elastically deformable rubber material, i.e., an elastic plastic material or a rubber elastic material can be used as the elastic material. In particular, the elastic material is compressible, formed, for example, as a foamed elastomer. Preferably, the elastic material is incompressible or not compressible. The elastic material and/or the elastomeric material may deform elastically under tensile and/or compressive stress. In particular, the elastic material can return to its original shape after the application of a force.

According to a further embodiment, the first spring leaf and/or the further spring leaf is/are formed from a fiber-reinforced plastic. In particular, the first spring leaf and/or the further spring leaf is made of a glass-fiber reinforced plastic. The first spring leaf and/or the further spring leaf can each be formed from a plurality of fiber layers. In particular, the fiber layers are impregnated by means of a matrix material and/or connected to each other. Preferably, the first spring leaf and the further spring leaf are each implemented as a fiber-reinforced plastic composite. The first spring leaf may be formed of a first fiber-reinforced plastic and the further spring leaf of a fiber-reinforced plastic differing from the first fiber-reinforced plastic. Thus, depending on the requirements and/or the desired progressive suspension characteristic of the leaf-spring device, different suitable materials can be combined. in particular, the first fiber-reinforced plastic, the further fiber-reinforced plastic and/or an elastic material are designed and/or selected to be matched for implementing a predetermined spring characteristic, preferably a predetermined progressive suspension. The use of fiber-reinforced plastic for the formation of the first spring leaf, the further spring leaf and/or the leaf-spring device makes for weight savings, especially in comparison with a leaf-spring device made of metal spring leaves.

According to a further embodiment, which is also conceivable separately and independently of the present application, either the first spring leaf or the further spring leaf can be made of a fiber-reinforced plastic. The respective further spring leaves may be made of a different material, in particular not of a fiber-reinforced plastic. The other material may be, for instance, a metal.

Preferably, the first spring leaf, the further spring leaf and the elastic material are designed to implement a progressive suspension and/or a progressive spring characteristic, wherein starting from an unstressed state of the leaf-spring device, the elastic material is increasingly deformed with increasing spring load thereby increasingly stressing the further spring leaf. In particular, the elastic material is increasingly deformed, compressed and/or compacted with increasing spring stress, Accordingly, in particular starting from or simultaneously to a predetermined spring load and/or acting spring force, the further spring leaf is increasingly stressed, rendering the leaf-spring device increasingly stiffer upon increasing spring load. In that way, the rigidity of the leaf-spring device can be increased as a function of an increasing spring load. As a result, a progressive suspension and/or spring characteristic can be implemented. In particular, the elastic material, preferably up to a predetermined spring load and/or acting spring force, causes an at least partial decoupling of the first spring leaf from the further spring leaf. Until the predetermined spring load and/or acting spring force is reached, a bending stress cannot or can only partially be transferred from the first spring leaf to the further spring leaf via the elastic material. The further spring leaf can only be stressed according to the bending of the first spring leaf starting from the predetermined spring load and/or acting spring force. In particular, the elastic material cannot be deformed further starting from the predetermined spring load and/or acting spring force, but can only return towards its initial shape from a maximum deformed state as a function of a decreasing spring load and/or acting spring force.

According to one development, the further spring leaf and/or an elastic material is/are arranged completely within the first spring leaf, in particular in the receiving space. The receiving space may be formed as a hollow chamber in the first spring leaf. The receiving space of the first spring leaf can be partially or completely filled by the further spring leaf and/or the elastic material. The further spring leaf and/or the elastic material may be completely surrounded by the first spring leaf, In particular, the further spring leaf can be completely surrounded or enclosed by the elastic material. As a result, the further spring leaf is reliably protected from environmental influences.

Preferably, the receiving space is formed as a through hole. The through hole can extend from a first side of the first spring leaf to a second side of the first spring leaf facing away from the first side. In particular, the receiving space in the vehicle and/or in a chassis extends transversely or perpendicular to a vertical vehicle axis in a mounted state of the leaf-spring device. The through hole can be partially or completely filled by the further spring leaf and/or the elastic material. The first spring leaf and the further spring leaf can have the same width. In particular, the further spring leaf and/or the elastic material is/are visible from the outside. With increasing spring load, the elastic material can be deformed, pressed and/or pushed in the longitudinal direction of the through hole. In this case, the elastic material can partially emerge and/or bulge from the through hole.

Preferably, the first spring leaf and/or the further spring leaf is/are formed as mirror images to a center plane. The center plane may extend at right angles to a longitudinal axis or longitudinal extent of the leaf-spring device and/or a longitudinal axis of the vehicle. Alternatively, the center plane may extend parallel to a longitudinal axis or longitudinal extent of the leaf-spring device and/or a longitudinal axis of the vehicle. In particular, the center plane is oriented vertically and/or in the direction of a vertical axis in a mounted state of the leaf-spring device in a chassis and/or in a vehicle. Thus, the center plane may be located in a vertical plane and/or a plane, or the center plane may coincide with a vertical plane and/or a normal plane. The longitudinal axis of the leaf-spring device can extend through two attachment devices at the ends facing away from each other for fastening the leaf-spring device to a vehicle beam, vehicle sub-frame, vehicle frame and/or vehicle body. In particular, two end fastening devices facing away from each other are used as fasteners for the leaf-spring device. Furthermore, the leaf-spring device can be connected to an axle in a central area, in particular centrally between the two attachment devices at the end. This axle may be formed as a wheel axle and/or rigid axle. In particular, in a mounted state in a vehicle and/or in a chassis, the axle extends in a direction transverse or perpendicular to the longitudinal axis of the vehicle.

According to a further embodiment, the first spring leaf, the further spring leaf and/or the receiving space has/have an arcuate or curved shape, in particular in an unstressed state of the leaf-spring device. In particular, the arcuate or curved shape is directed towards an axle connected to the leaf-spring device.

According to a further development, the receiving space, in particular in an unstressed state of the leaf-spring device, has a convex curved inner side and a concave curved inner side. The convex curved inner side may be regarded as a first inner side and the concave curved inner side may he considered as a second inner side of the receiving space. The convex curved inner side and the concave curved inner side may extend in the longitudinal direction of the first spring leaf. The convex curved inner side and the concave curved inner side can merge into each other in sections of the receiving space at the end, in particular in sections facing away from each other. Preferably, the convex curved inner side and the concave curved inner side are arranged opposite from each other and/or facing each other.

The unloaded state of the leaf-spring device may refer to an unmounted state of the leaf spring mount with respect to the assembly in a chassis and/or vehicle. Alternatively, the unloaded condition of the leaf-spring device may refer to the mounted state of the leaf-spring device in a vehicle and/or suspension, wherein a spring load is acting on the leaf-spring device, which corresponds at most to the spring load in an empty state or in an unloaded state of the vehicle.

According to a further embodiment, two end areas of the further spring leaf facing away from each other are arranged at a shorter distance from the concave curved inner side than from the convex curved inner side, in particular in an unstressed state of the leaf-spring device. A first end area of the further spring leaf can face a first end of the first spring leaf and a second end area of the further spring leaf can face a second end of the first spring leaf. Because of a suitable arrangement and/or design of the further spring leaf in the receiving space of the first spring leaf, the suspension properties of the leaf-spring device can be influenced, specified or adjusted.

Preferably, a central area of the further spring leaf is arranged at a shorter distance from the concave curved inner side than from the convex curved inner side, in particular in an unstressed state of the leaf-spring device. in that way, the distance between the inner circumference of the receiving space of the first spring leaf and the outer circumference of the further spring leaf can be formed differently along the longitudinal extension of the leaf-spring device. In an alternative embodiment, the distance between the inner circumference of the receiving space and the outer circumference of the further spring leaf can be made constant and/or the same length along the length of the further spring leaf. In particular, the distance between the inner circumference of the receiving space and the outer circumference of the further spring leaf is completely or partially filled by the elastic material, In particular, the central area is arranged centrally between two end areas of the further spring leaf.

According to the method for manufacturing a leaf-spring device according to the invention, a first spring leaf and at least one further spring leaf, in particular each made of a fiber-reinforced plastic, are manufactured. The first spring leaf and the further spring leaf interact to implement a progressive suspension and/or progressive spring characteristic. The first spring leaf is formed such that it has a receiving space and the further spring leaf is arranged in the receiving space.

Preferably, an elastic material, preferably an elastomeric material, is arranged in the receiving space and between the first spring leaf and the further spring leaf. In particular, the first spring leaf, the further spring leaf and the elastic material are manufactured in layers and/or layer-like. Preferably, the leaf-spring device is built up and/or manufactured in layers and/or layer-like. Thus, the leaf-spring device as such or as a whole can be implemented and/or constructed in layers. A first and/or bottom portion of the first spring leaf can be built and/or manufactured first. Subsequently, a first and/or bottom portion of the elastic material is built and/or manufactured on the first and/or bottom portion of the first spring leaf. Then, the further spring leaf can be built and/or manufactured on the first and/or bottom portion of the elastic material. Subsequently, a further and/or top portion of the elastic material can be built and/or manufactured on the further spring leaf. After that, a further and/or top portion of the first spring leaf can be built and/or manufactured on the further and/or top portion of the elastic material. In parallel and/or simultaneous to the building or manufacturing of the elastic material areas and/or the further spring leaf, end areas of the first spring leaf can be bunt and/or manufactured. These end areas can be used to implement a first end and a second end of the first spring leaf, After the construction of the leaf-spring device, a fiber-reinforced plastic of the first spring leaf and the further spring leaf can be consolidated and/or cured by means of a suitable method. This may be, for example, an RTM process (RTM: Resin Transfer Molding).

According to a further embodiment, the first spring leaf and the further spring leaf are manufactured first. In this case, the first spring leaf can be manufactured first and then the further spring leaf can be manufactured. Alternately, first the further spring leaf and then the first spring leaf can be manufactured. According to a further alternative, the first spring leaf and the further spring leaf can be manufactured simultaneously or in parallel, in particular independently of each other. Then, the elastic material is introduced between an inner circumference of the receiving space and an outer circumference of the further spring leaf to connect the first spring leaf to the further spring leaf, Alternatively, first the elastic material can be applied to the outer circumference of the further spring leaf after the latter's manufacture. Subsequently, the first spring leaf can be manufactured, such that the inner circumference of the receiving space of the first spring leaf rests against the elastic material. Alternatively, first the further spring leaf can be manufactured, in particular from individual fiber layers or fiber composite layers. Subsequently, the elastic material is arranged on the further spring leaf. The elastic material can be formed as an elastomeric insert. After arranging the elastic material, the first spring leaf can be manufactured, in particular from individual fiber layers or fiber composite layers. As a result, a continuous, in particular layered or layer-like, composition of the leaf-spring device is rendered possible. According to a further alternative, the first spring leaf and the further spring leaf and the elastic material can be manufactured simultaneously or in parallel, in particular independently of each other.

The use of such a leaf spring device according to the invention as a longitudinal leaf spring or a transverse leaf spring is of particular advantage in a chassis of a vehicle or motor vehicle.

In particular, the leaf-spring device manufactured according to the method according to the invention is a previously described leaf-spring device according to the invention. Preferably, the method is developed further according to all embodiments described in connection with the leaf-spring device according to the invention described here. Further, the leaf-spring device can be developed further according to all embodiments described in connection with the method according to the invention described here.

### BRIEF DESCRIPTION OF THE DRAWINGS

Below, the invention will be explained in more detail with reference to the figures. The same reference numerals refer to the same, similar or functionally identical components or elements., In the figures:

FIG. 1 shows a perspective view of the leaf-spring device according to the invention;

FIG. 2 shows a side view of the leaf-spring device according to the invention shown in FIG. 1,

FIG. 3 shows a detail of the leaf-spring device according to the invention shown in FIG. 2, and

FIG. 4 shows a cross section of the leaf-spring device according to the invention shown in FIG. 3.

### DETAILED DESCRIPTION OF THE PREFERRED EMBODIMENTS

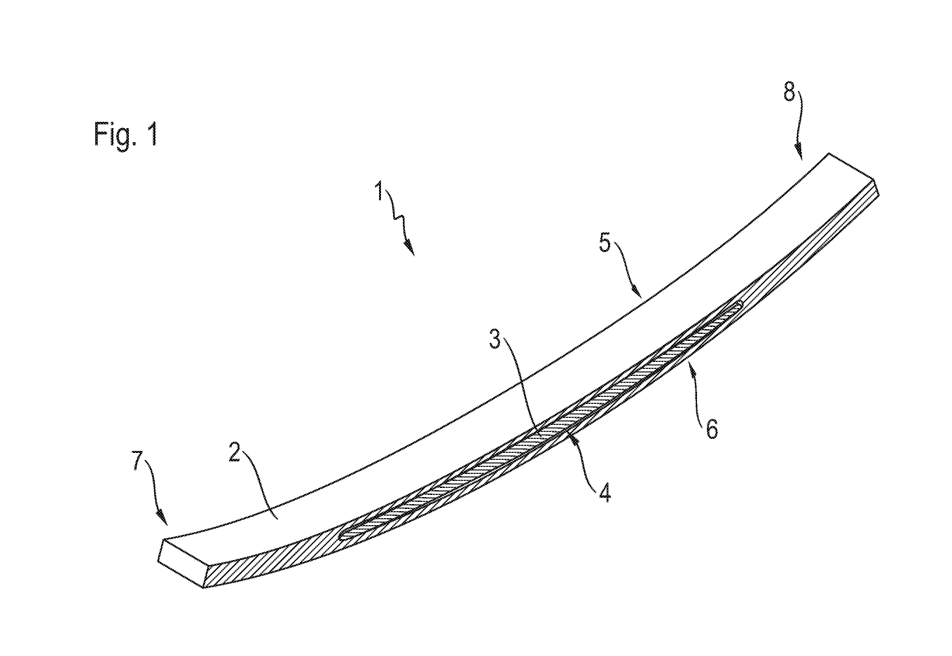

FIG. 1 shows a perspective view of a leaf-spring device 1 according to the invention. The leaf-spring device 1 has a first spring leaf 2 and a further spring leaf 3. In this embodiment, the further spring leaf 3 is formed as a second spring leaf. In all, the leaf-spring device 1 thus has two spring leaves, namely the first spring leaf 2 and the further spring leaf 3. The first spring leaf 2 and the further spring leaf 3 are each formed of a fiber-reinforced plastic, in this embodiment of a glass-fiber reinforced plastic. The further spring leaf 3 is shorter than the first spring leaf 2 in relation to the longitudinal extent of the leaf-spring device 1. Both the first spring leaf 2 and the further spring leaf 3 have a curved shape according to this example, in particular in an unstressed state. The further spring leaf 3 is arranged in a receiving space 4 of the first spring leaf 2. Thus, the further spring leaf 3 is disposed within the first spring leaf 2 and integrated into the first spring leaf 2.

In this embodiment, the receiving space 4 is formed as a through hole in the first spring leaf 2. The receiving space 4 extends from a first side 5 of the first spring leaf to a second side 6 of the first spring leaf 2 facing away from the first side 5. In this exemplary embodiment, the leaf-spring device 1 is formed as a longitudinal leaf spring. Thus, the receiving space 4 or a longitudinal axis of the through opening 4 forming the receiving space extends transversely or perpendicular to a vertical vehicle axis in a mounted state of the leaf-spring device 1 in a vehicle and/or in a chassis not shown here.

The first leaf spring 2 has a first end 7 and a second end 8 facing away from the first end 7. The two ends 7, 8 are formed as free ends. The leaf-spring device 1 can be fastened to a vehicle beam, vehicle frame and/or vehicle body by means of two attachment devices arranged opposite from each other and arranged in the area of the end 7 or 8 and not shown here.

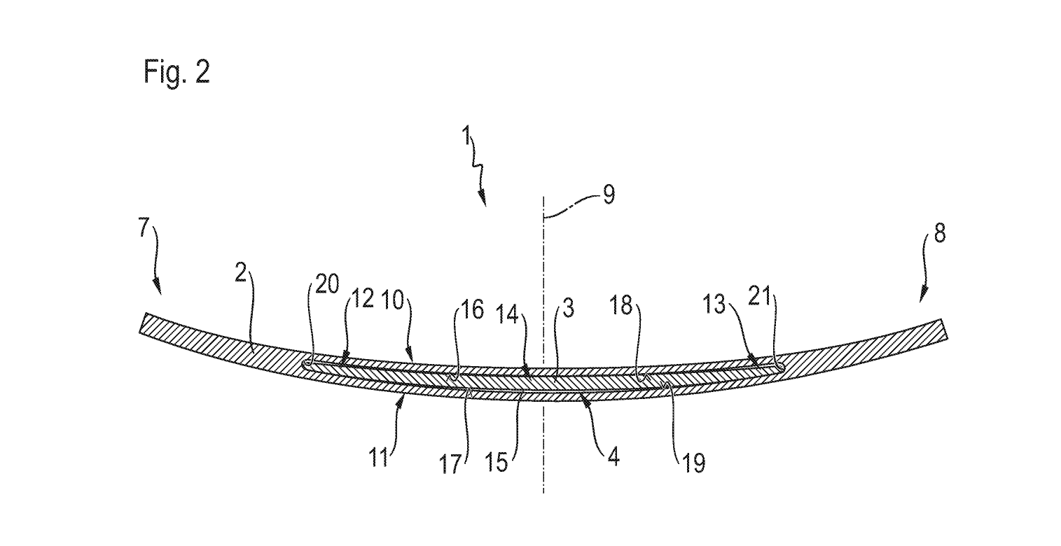

FIG. 2 shows a side view of the leaf-spring device 1 according to the invention as shown in FIG. 1. The spring leaf 2, the further spring leaf 3 and the receiving space 4 are formed as mirror images to a center plane 9. In an assembled state of the leaf-spring device 1, the center plane 9 is oriented vertically. In this exemplary embodiment the center plane 9 furthermore extends perpendicular to the longitudinal extent of the leaf-spring device 1. Alternatively, a center plane may extend exclusively in parallel to the longitudinal extent of the leaf-spring device 1. In the formation of the leaf-spring device 1 as a longitudinal leaf spring, in the mounted state the center plane 9 also extends perpendicular to a longitudinal axis of a vehicle. Furthermore, the first leaf-spring device 1 has a curved shape. As a result, the leaf-spring device 1 or the first spring leaf 2 has a concave outer side 10 and a convex outer side 11.

The further spring leaf 3 has a first end area 12 and a second end area 13 facing away therefrom. In this case, the first end area 12 faces the first end 7 of the first spring leaf 2 and the second end area 13 faces the second end 8 of the first spring leaf 2, but in each case is spaced apart from this end 7, 8, The further spring leaf 3 has a central area 14 in the center between the two end areas 12, 13.

An elastic material 15 is arranged between the first spring leaf 2 and the further spring leaf 3 In this exemplary embodiment, the elastic material 15 is formed as an elastomeric material. The elastic material 15 contacts an inner circumference 16 of the receiving space 4 on the one hand and an outer circumference 17 of the further spring leaf 3 on the other hand.

The inner circumference 16 is formed by means of a convex curved inner side 18, a concave curved inner side 19 and end-side sections 20, 21 of the receiving space 4 interconnecting the two inner sides 18, 19.

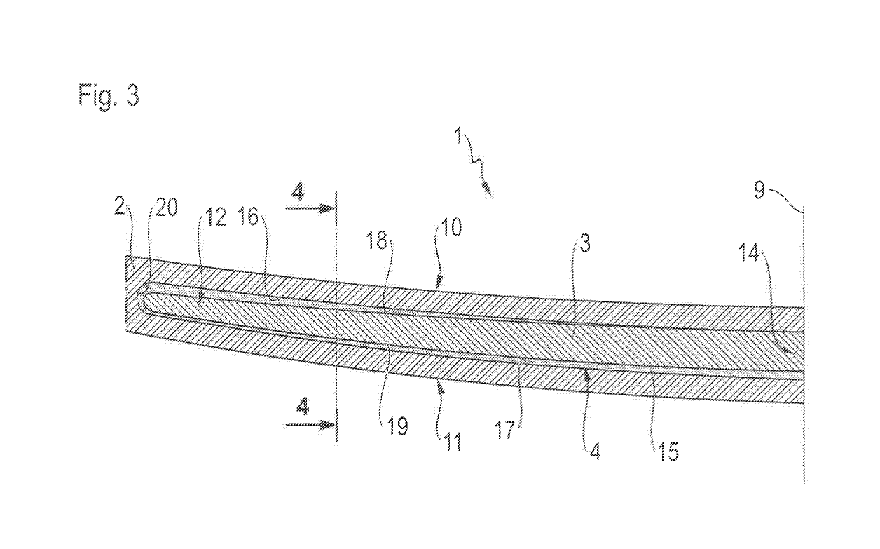

FIG. 3 shows a detail of the side view of the leaf-spring device 1 according to the invention as shown in FIG. 2. In the unstressed state of the leaf-spring device 1 shown here, the first end area 12 of the further spring leaf 3 is arranged at a shorter distance from the concave curved inner side 19 than from the convex curved inner side 18. An analogous arrangement results for the end area 13 formed as a mirror image as shown in FIG. 2.

Furthermore, in the unstressed state of the leaf-spring device 1 shown here, the central area 14 is arranged at a shorter distance from the convex curved inner side 18 than from the concave curved inner side 19. As a result, more elastic material 15 is arranged in the areas having greater distance between the outer circumference 17 of the further spring leaf 3 and the inner circumference 16 of the first spring leaf 2 than in the regions having smaller distances.

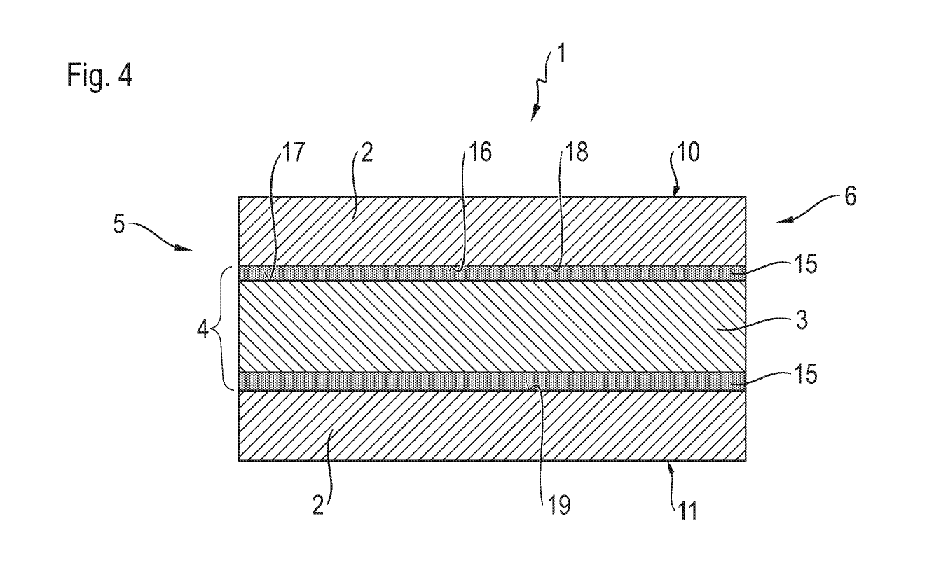

FIG. 4 shows a cross section 4-4 of the leaf-spring device according to the invention 1 as shown in FIG. 3. It can be clearly seen that the receiving space 4 is formed as a through hole extending from the first side 5 to the second side 6 of the first spring leaf 2. In this exemplary embodiment, the receiving space is completely filled by the further spring leaf 3 and the elastic material 15, In this case, the further spring leaf 3 and the elastic material 15 are flush with the sides 5 and 6, respectively. Alternatively, the elastic material can have an inwardly facing or concave depression.

Starting from the unstressed state as shown in FIGS. 1 to 4, the elastic material 15 is increasingly deformed with increasing spring bad and then successively or simultaneously the further spring leaf is increasingly stressed 3. There, the spring bad from the convex outer side 10 acts in the direction of the concave outer side 11. In an assembled state of the leaf-spring device 1, the spring bad is directed in the vertical direction from bottom to top or in the direction of the vertical axis of the vehicle.

Due to the interaction of the first spring leaf 2, the further spring leaf 3 and the elastic material 15, the leaf-spring device 1 can be used to implement a progressive suspension or progressive spring characteristic. in this case, due to the elastic material 15 between the two spring leaves 2, 3, damage to the spring leaves 2, 3, formed from a fiber-reinforced plastic is prevented.

For a desired suspension behavior of the leaf-spring device 1, the first spring leaf 2, the further spring leaf 3, the receiving space 4 and/or the elastic material 15 can be suitably formed or adapted. This design or adaptation may relate to the shape, contour or material properties.

### REFERENCE NUMERALS

1. leaf-spring device
2. first spring leaf
3. further spring leaf
4. receiving space
5. first side
6. second side
7. first end
8. second end
9. center plane
10. concave outer side
11. convex outer side
12. first end area
13. second end area
14. central area
15. elastic material
16. inner circumference
17. outer circumference
18. convex inner side
19. concave inner side
20. end-side section
21. end-side section

1-14. (canceled)

15. A leaf-spring device for a vehicle, the leaf-spring device comprising:
a first spring leaf (2),
at least one further spring leaf (3),
the first spring leaf (2) and the further spring leaf (3) interacting to implement a progressive suspension,
the first spring leaf (2) having a receiving space (4), and
the further spring leaf (3) being arranged in the receiving space (4).

16. The leaf-spring device according to claim 15, wherein an elastic material (15) is arranged in the receiving space (4), between the first spring leaf (2) and the further spring leaf (3), and the elastic material (15) contacts an inner circumference (16) of the receiving space (4) and an outer circumference (17) of the further spring leaf (3).

17. The leaf-spring device according to claim 16, wherein the first spring leaf (2) is made of a first fiber-reinforced plastic and the further spring leaf (3) is made of a further fiber-reinforced plastic which differs from the first fiber-reinforced plastic, at least one of the first fiber-reinforced plastic, the further fiber-reinforced plastic and the elastic material is designed or selected to be matched for implementing a predetermined spring characteristic.

18. The leaf-spring device according to claim 16, wherein at least one of the first spring leaf, the further spring leaf (2) and the elastic material (15) are designed to implement at least one of a progressive suspension and a progressive spring characteristic, and starting from an unstressed state of the leaf-spring device (1), the elastic material (15) is at least one of increasingly deformed and compressed upon increasing spring load such that the further spring leaf (3) is increasingly stressed.

19. The leaf-spring device according to claim 16, wherein at least one of the further spring leaf (3) and the elastic material (15) is arranged completely within the first spring leaf (2), the receiving space (4) is designed as a cavity in the first spring leaf (2), and at least one of the further spring leaf (3) and the elastic material (15) is completely surrounded by the first spring leaf (2).

20. The leaf-spring device according to claim 15, wherein the receiving space (4) is a through hole and extends from a first side (5) of the first spring leaf (2) to a second side (6) of the first spring leaf (2) facing away from the first side (5) of the first spring leaf (2), and the receiving space (4) extends perpendicular to a vehicle vertical axis in a mounted state of the leaf-spring device (1) in the vehicle.

21. The leaf-spring device according to claim 15, wherein at least one of the first spring leaf (2) and the further spring leaf (3) is formed as a mirror image to a median plane (9), the median plane (9) extends either parallel or perpendicular to a longitudinal axis of the leaf-spring device (1), and the longitudinal axis of the leaf-spring device (1) extends through two end fastening devices facing away from each other for fastening the leaf-spring device (1) to at least one of a vehicle carrier and a vehicle body.

22. The leaf-spring device according to claim 15, wherein at least one of the first spring leaf (2), the further spring leaf (3) and the receiving space (4) has either a curved or arcuate shape in an unstressed state of the leaf-spring device (1).

23. The leaf-spring device according to claim 15, wherein the receiving space (4), in an unstressed state of the leaf-spring device(1), has a convex curved inner side (18) and a concave curved inner side (19), the convex curved inner side (18) and the concave curved inner side (19) extend in a longitudinal direction of the first spring leaf (2), and the convex curved inner side (18) and the concave curved inner side (19) are at least one of arranged opposite from each other and facing each other.

24. The leaf-spring device according to claim 23, wherein two end areas (12, 13) of the further spring leaf (3) facing away from each other are arranged at a shorter distance from the concave curved inner side (19) than from the convex curved inner side (18) in an unstressed state of the leaf-spring device (1), a first end area (12) of the further spring leaf (3) faces a first end (7) of the first spring leaf (2) and a second end area (13) of the further spring leaf (3) faces a second end (8) of the first spring leaf (2).

25. The leaf-spring device according to claim 23, wherein a central region (14) of the further spring leaf (3), in an unstressed state of the leaf-spring device (1), is arranged at a shorter distance from the convex curved inner side (18) than to the concave curved inner side (19), and the central area (14) is arranged centrally between two end areas (12, 13) of the further spring leaf (3).

26. A method for manufacturing a leaf-spring device for a vehicle, the leaf-spring device has a first spring leaf (2) and at least one further spring leaf (3), the first spring leaf (2) and the further spring leaf (3) interact with one another to implement a progressive suspension, the first spring leaf (2) has a receiving space (4) and the further spring leaf (3) is arranged in the receiving space (4), the method comprising:
manufacturing a first spring leaf (2) and at least one further spring leaf (3), and interacting the first spring leaf (2) with the further spring leaf (3) to implement at least one of a progressive suspension and spring characteristic,
providing the first spring leaf (2) with a receiving space (4), and
arranging the further spring leaf (3) in the receiving space (4).

27. The method according to claim 26, further comprising arranging an elastic material (15) in the receiving space and between the first spring leaf (2) and the further spring leaf (3) such that the first spring leaf (2), the further spring leaf (3) and the elastic material (15) are manufactured in at least one of a layered form and a layer-like form and the leaf-spring device (1) is at least one of constructed and manufactured in at least one of layers and layer-like.

28. The use of such a leaf spring device (1) according to claim 15 as either a longitudinal leaf spring or a transverse leaf spring in a chassis of either a vehicle or a motor vehicle.

29. A leaf-spring device for a vehicle, the leaf-spring device comprising:
a first spring leaf defining a longitudinal axis and having a longitudinally extending through hole that forms a receiving space, and the receiving space laterally spanning through the first spring leaf; and
at least one further spring leaf being arranged within the receiving space such that the first spring leaf and the further spring leaf interact with one another to implement a progressive suspension.

30. The leaf-spring device according to claim 29, wherein an elastic material is arranged in the receiving space between the first spring leaf and the further spring leaf, and the elastic material contacting an inner circumference of the receiving space and an outer circumference of the further spring leaf.
